(19) United States
(12) Patent Application Publication
(10) Pub. No.: US 2020/0089783 A1
(43) Pub. Date: Mar. 19, 2020

(54) COLLATING FILE CHANGE SETS AS ACTION GROUPS

(71) Applicant: INTERNATIONAL BUSINESS MACHINES CORPORATION, ARMONK, NY (US)

(72) Inventors: STEVEN J. HORSMAN, FARNBOROUGH (GB); KEVIN C. BOWKETT, FAIR OAK (GB)

(21) Appl. No.: 16/131,071

(22) Filed: Sep. 14, 2018

(51) Int. Cl. G06F 17/30; G06F 21/62

(52) U.S. Cl. CPC G06F 17/30144; G06F 17/3012; G06F 21/6218

(57) ABSTRACT

A method is provided in which a user can access to file. An action group is created that comprises a change set comprising changes to the file and metadata comprising information relating to the change set. User actions taken with respect to the file are monitored and the change set of the action group are updated if the file is changed. Information is collected relating to the user actions and the metadata of the action group is updated with information relating to the user actions. If a user action that defines an endpoint of a change set is detected, the action group is completed.

### BACKGROUND

The present invention relates to a computer implemented method, a data processing system and a computer program product for tracking change sets relating to a file.

### SUMMARY

According to a first aspect of the present invention, there is provided a computer-implemented method comprising providing user access to a file, creating an action group comprising a change set comprising changes to the file and metadata comprising information relating to the change set, monitoring user actions taken with respect to the file and updating the change set of the action group if the file is changed, collecting information relating to the user actions and updating the metadata of the action group with information relating to the user actions, determining if a user action defines an endpoint of a change set, and completing the action group if it is determined that a user action defines an endpoint of a change set.

According to a second aspect of the present invention, there is provided a data processing system comprising a processor arranged to provide user access to a file, create an action group comprising a change set comprising changes to the file and metadata comprising information relating to the change set, monitor user actions taken with respect to the file and update the change set of the action group if the file is changed, collect information relating to the user actions and update the metadata of the action group with information relating to the user actions, determine if a user action defines an endpoint of a change set, and complete the action group if it is determined that a user action defines an endpoint of a change set.

According to a third aspect of the present invention, there is provided a computer program product for controlling a data processing system comprising a processor, the computer program product comprising a computer readable storage medium having program instructions embodied therewith, the program instructions executable by the processor to cause the processor to provide user access to a file, create an action group comprising a change set comprising changes to the file and metadata comprising information relating to the change set, monitor user actions taken with respect to the file and update the change set of the action group if the file is changed, collect information relating to the user actions and update the metadata of the action group with information relating to the user actions, determine if a user action defines an endpoint of a change set, and complete the action group if it is determined that a user action defines an endpoint of a change set.

### BRIEF DESCRIPTION OF THE DRAWINGS

Embodiments of the present invention will now be described, by way of example only, with reference to the following drawings, in which:—

FIG. 1 is a schematic diagram of a file and an action group:

FIG. 2 is a flowchart of a process for creating action groups:

FIG. 3 is a schematic diagram of a data processing system: and

FIG. 4 is a schematic diagram of a graphical user interface.

### DETAILED DESCRIPTION

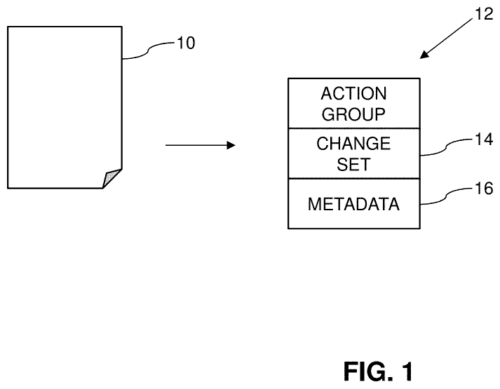

FIG. 1 shows schematically a file 10 and an action group 12. The action group 12 has two principal components, a change set 14 and metadata 16. The file 10 could be a standard text file containing text for use with a text editor or a word processing application. Equally the file 10 could be a source code file that forms part of a computer program that is to be compiled into object code. A change set 14 is a set of code/configuration changes that are atomic. In a typical source code management system, a change set 14 is displayed as a list of differences between two versions of a file 10.

A code review is a popular software engineering practice, whereby a user who was not involved in the development of a piece of code defined by a file 10, examines the file 10 in order to spot mistakes and offer suggestions for improvement. Currently, code reviews are conducted by examining the differences between the “before” and “after” version of each file 10 that has been modified. The reviewer is typically presented with a list of files 10 that are sorted by file path, alphabetically. In a large software product, there may be very large numbers of files 10 that make up the overall product. The code review process can present a number of challenges, which are explained in detail below.

A common problem is a lack of context in that it can be very difficult for a reviewer to see which changes are dependent on other changes. The alphabetical ordering of files rarely, if ever, aligns with the logical or contextual ordering of changes. Even within a single file 10, there could be several changes that are ordered top-to-bottom, which again may not necessarily help the reviewer understand their context or the order in which they were implemented. Coding is an iterative process, and it is often helpful for the reviewer to understand the iterations the code went through before reaching its final state. For example, a coder may create several code files that work together, but whose names are alphabetically dissimilar. The reviewer will need to either repeatedly switch back and forth between each file, or make notes to help keep track of the changes or rely on their memory. None of these is an effective solution since all are prone to human error and counter-productive to the review process.

Another common problem relates to computer-generated changes. Modern integrated development environments (IDE) provide useful features such as renaming, refactoring and formatting white space. When a coder makes use of such a feature, a change is recorded in each affected file and becomes part of the change set. These “computer generated” changes affect the source code, but not the actual functionality of the code (the compiled code is typically not affected at all). Whilst these changes can be important to review, they can often create “noise” in the review process due to the sheer volume of differences that are generated because of a single user action. This is again counter-productive to a review process and creates a risk of a non-computer generated change being overlooked by the reviewer, because of the presence of “noise” within the same source code file 10. For example, a coder may rename a constant which is referenced by dozens of files. The reviewer will need to review each of these separately. The affected files may span several different packages and even different change sets. This causes significant delay and frustration, as the process is necessary but highly inefficient. One of the amended files may also contain a small but significant change which is unrelated to the renaming. There is a high probability of this change being overlooked.

One of the recommended practices for software development is frequent check-in/commit of code into change sets, whenever a feature has been successfully implemented without breaking any other functionality. This provides a very useful rollback point for the coder, which can be utilized if they subsequently make a mistake or attempt an unsuccessful refactoring of code. However, checking in regularly can be a tedious process, and relies on human memory and discipline. Automating this process eases the burden on the coder, and avoids missing out on a vital rollback point.

Change sets often need to be merged since while a coder is implementing a change, another coder can deliver their own change to the main branch that affects the same files. This change needs to be “merged in”, which entails closely examining each modified line on each affected file, and carefully picking out what needs to be copied across. Again, this is a tedious and error-prone process.

Tracking change sets as action groups 12 can significantly improve the user experience for code reviewers, and make the process more efficient and less error-prone. It can also provide benefits to the coder by facilitating auto check-in and easier merging. The use of action groups 12 provides an alternative way of recording and reviewing change sets, based on user actions as opposed to differences between versions of a file. This is achieved by monitoring user actions that result in code changes, recording these actions and tagging them with metadata to provide context. Thus, a large set of computer-generated changes across different files and packages (such as renaming a constant) can be recorded and reviewed as a single user action with an appropriate tag (such as “Rename X->Y”).

The use of action groups 12 also facilitates a “replay” feature, whereby a reviewer can replay the coder's actions in the order they were taken, and thus potentially gain a much better understanding of how a change was implemented, what iterations it went through, and why certain decisions were made. By breaking down a large code review into several smaller reviews that are sensibly grouped, the use of action groups 12 allows the reviewer to have far more clarity on how the changes work together, as unrelated changes will be isolated to a different review group. Computer generated changes will be summarised in a linked action group 12, so their wide-ranging effects are isolated from other changes, thus eliminating the “noise” and avoiding the risk of the refactor/format masking another, unrelated change.

Overall, this action replay style of grouped code reviews makes doing a thorough review far easier and less taxing. An additional benefit of creating action groups automatically is that this process reduces the overhead of checking in and merging manually. If the coder needs to undo or rollback an action, then the coder can use the action group editor and pick which action groups they want to “rewind”.

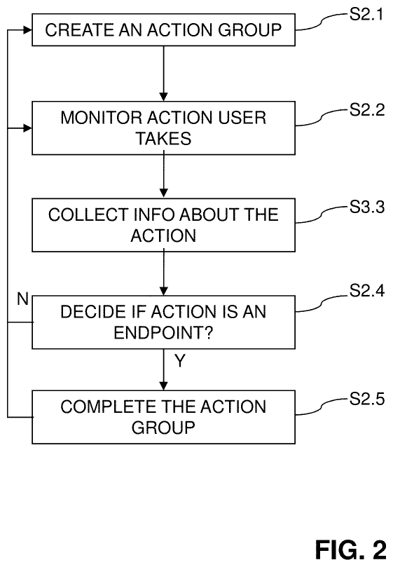

FIG. 2 shows more detail of the automated process of using action groups. Step S2.1 comprises creating an action group 12. An action group 12 comprises a change set 14 (a group of file changes) and metadata 16 detailing information about the action group 12 (such as whether the change set 14 was computer generated, and if so what was the user action that triggered the changes). Step S2.2 comprises monitoring actions the user takes. Modern IDEs have extension points to allow users to create plugins for them. These extension points can be used to add a listener to monitor any actions that the user takes. Examples of actions that can be monitored could be creating a new test, running a test suite, developing code, triggering a refactor. These actions either cause a source code change, or can be used for sync point analysis.

Step S2.3 comprises collecting information about the user's action. For example, if the action collected is a source code change then information about the change can be appended to the metadata 16. Step S2.4 comprises deciding if the action is a sync point. Sync points are actions that can be used to split a change set up into action groups 12. This could be user configured, or manual, but the process would provide some built in ones to determine when an action group 12 is completed.

Some examples of these could be, firstly running a test suite successfully (i.e. with no test failures or errors). A common development methodology is to use Test Driven Development (TDD), whereby a user creates a failing test case for a new feature, then writes code and re-runs the test until it passes. This is designed to be a quick loop of actions. Under this scenario, getting a passing test suite indicates the end of an iteration and that the feature is “complete”. This is a natural point where it will be useful to break up the change set 14 into a discrete action group 12.

Other examples of actions that could be considered sync points include a user checking-in code since if the user is manually checking in code they usually will do this regularly once a small piece of the change set 14 is complete, triggering a rename/refactor so that when a computer-generated change is completed, such as renaming a constant, class, or package, the process will want to isolate this change, as outlined above and finally a manual sync point can be produced for example via a button in the UI for the user to create a manual sync point. Over time, using information about the actions done and when users manually sync, the process can utilize machine learning to more accurately create our automatic sync points.

The final step of the process is step S2.5, which comprises completing the action group 12. Once the action group 12 is complete, the metadata 16 will be stored along with any other information related to the change set 14, automatically checked in and persisted in the source code management system for convenient storage and sharing.

The process creates a set of action groups 12 that can be reviewed at a later date. When the code reviewer wants to review a change set, they will look at the source code management system and get access to the file changes and the metadata. Using the metadata and information about the action groups it is possible to create a UI which lists the action groups 12 in order and allows reviewing them either one at a time, or grouping them contextually, or replaying them as outlined above.

Although the above embodiment is described with respect to changes made to a software product, in a broader application, a word processor could record user actions such as changing a font or moving text from one page to another, and group these actions in a logical way, to facilitate the reviewing process and provide the ability to replay. Changes made by the user are grouped together to form individual action groups 12 which allow all of the changes between two versions of the same file 10 (whether a simple text file or a more complex source code file) to be looked at from a logical level with changes that are related to each other grouped together in single action groups 12.

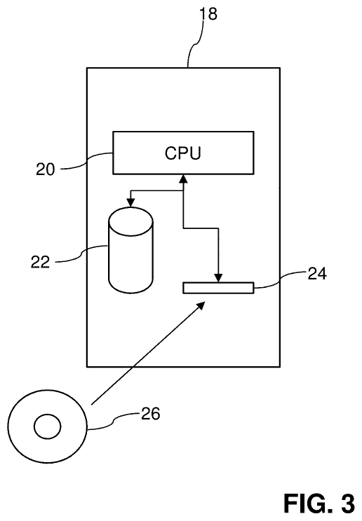

The process shown in FIG. 2 is preferably carried out by a data processing system. FIG. 3 shows one embodiment of a data processing system 18. The system 18 comprises a processor 20, which is controlling the operation of the data processing system 18. The processor 20 of the data processing system 18 is also connected to a local storage device 22 and to a local interface 24. A computer readable storage medium 26 is provided, which is a CD-ROM 26 storing a computer program product that can be used to control the processor 20 to operate the data processing system 18. The processor 20 executes instructions from the computer program product to operate the data processing system 18.

The processor 20 is operated to provide user access to a file 10 (which may itself be comprised of a plurality of files or other sub-components). In a continuous process, the processor 20 is arranged to create an action group 12 comprising a change set 14 comprising changes to the file 10 and metadata 16 comprising information relating to the change set 14, monitor user actions taken with respect to the file 10 and update the change set 14 of the action group 12 if the file 10 is changed, and collect information relating to the user actions and update the metadata 16 of the action group 12 with information relating to the user actions.

The processor 20 determines if a user action defines an endpoint of a change set 14, and completes the action group 12 if it is determined that a user action defines an endpoint of a change set 14. The determining if a user action defines an endpoint of a change set 14 can be as the result of receiving a specific user input defining an endpoint of a change set 14. In this case, rather than determining algorithmically that an action group 12 should be completed, the processor 20 will respond to a direct instruction from the user that the current action group 12 can be completed. The processor 20 repeats the creating of action groups 12, populating the action groups 12 with change sets 14 and metadata 16 and completing the action groups 12 until the user has completed their current work on the file 10.

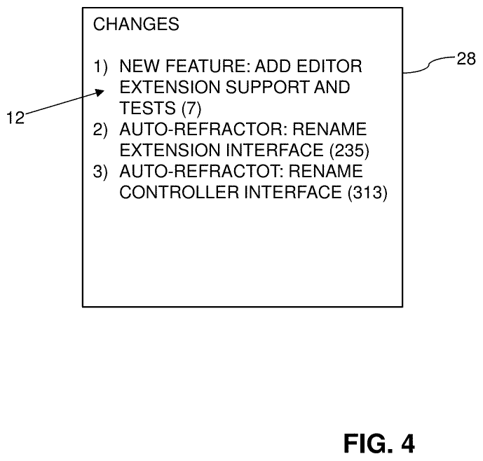

The processor 20 can also be operated to output a summary comprising a set of completed action groups 12. This can be seen in FIG. 4, which shows a graphical user interface 28, which shows that a set of changes made to a file 10 has been grouped into three separate action groups 12. Originally, the changes made to the file 10 were listed as many hundreds of individual changes to sub-components of the file 10, ordered alphabetically according to the name of the sub-components of the file 10 that has been changed. These changes have now been grouped into only three different action groups 12, which show the changes to the file 10 in their logical sense. This makes the changes much easier to understand and to review.

The processor 20 can also be controlled to output a set of possible endpoints of a change set 14, receive a user input selecting one or more of the possible endpoints of a change set 14 and use the selected one or more possible endpoints of a change set 14 in the determination as to whether a user action defines an endpoint of a change set 14. In this way, a user can access a menu of options that allows the user to see which actions are to be considered as endpoints (or sync points). The user can then make choices as to which of their actions can be considered automatically as a point at which to complete an action group 12.

The menu of possible endpoints can also be populated automatically and updated over time as the processor 20 monitors the user's actions. For example, since the processor 20 provides the ability for the user to automatically complete an action group 12 of their own volition, the processor 20 can monitor the point at which a user makes such a choice. The previous user action prior to the user completing the action group 12 themselves can then be added to the endpoints that are monitored by the processor 20. This new endpoint can be added to the set of possible endpoints of a change set 14, which the user can select and unselect from at any time.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer implemented method comprising:
providing user access to a file;
creating an action group comprising a change set comprising changes to the file and metadata comprising information relating to the change set;
monitoring user actions taken with respect to the file and updating the change set of the action group if the file is changed;
collecting information relating to the user actions and updating the metadata of the action group with information relating to the user actions;
determining if a user action defines an endpoint of a change set; and
completing the action group if it is determined that a user action defines an endpoint of a change set

2. A method according to claim 1, wherein the step of determining if a user action defines an endpoint of a change set comprises receiving a specific user input defining an endpoint of a change set.

3. A method according to claim 1, and further comprising repeating the creating of the action groups, populating the action groups with change sets and metadata and completing the action groups.

4. A method according to claim 3, and further comprising outputting a summary comprising a set of completed action groups.

5. A method according to claim 1, and further comprising outputting a set of possible endpoints of a change set, receiving a user input selecting one or more of the possible endpoints of a change set and using the selected one or more possible endpoints of a change set in the step of determining if a user action defines an endpoint of a change set.

6. A data processing system comprising a processor arranged to:
provide user access to a file;
create an action group comprising a change set comprising changes to the file and metadata comprising information relating to the change set;
monitor user actions taken with respect to the file and update the change set of the action group if the file is changed;
collect information relating to the user actions and update the metadata of the action group with information relating to the user actions;
determine if a user action defines an endpoint of a change set; and
complete the action group if it is determined that a user action defines an endpoint of a change set.

7. A system according to claim 6, wherein the processor is arranged, when determining if a user action defines an endpoint of a change set, to receive a specific user input defining an endpoint of a change set.

8. A system according to claim 6, wherein the processor is further arranged to repeat the creating of the action groups, populating the action groups with change sets and metadata and completing the action groups.

9. A system according to claim 8, wherein the processor is further arranged to output a summary comprising a set of completed action groups.

10. A system according to claim 6, wherein the processor is further arranged to output a set of possible endpoints of a change set, receive a user input selecting one or more of the possible endpoints of a change set and use the selected one or more possible endpoints of a change set in the determining whether a user action defines an endpoint of a change set.

11. A computer program product for controlling a data processing system comprising a processor, the computer program product comprising a computer readable storage medium having program instructions embodied therewith, the program instructions executable by the processor to cause the processor to:
provide user access to a file;
create an action group comprising a change set comprising changes to the file and metadata comprising information relating to the change set;
monitor user actions taken with respect to the file and update the change set of the action group if the file is changed;
collect information relating to the user actions and update the metadata of the action group with information relating to the user actions;
determine if a user action defines an endpoint of a change set; and
complete the action group if it is determined that a user action defines an endpoint of a change set.

12. A computer program product according to claim 11, wherein the instructions for determining if a user action defines an endpoint of a change set comprise instructions for receiving a specific user input defining an endpoint of a change set.

13. A computer program product according to claim 11, and further comprising instructions for repeating the creating of the action groups, populating the action groups with change sets and metadata and completing the action groups.

14. A computer program product according to claim 13, and further comprising instructions for outputting a summary comprising a set of completed action groups.

15. A computer program product according to claim 11, and further comprising instructions for outputting a set of possible endpoints of a change set, receiving a user input selecting one or more of the possible endpoints of a change set and using the selected one or more possible endpoints of a change set in the step of determining if a user action defines an endpoint of a change set.
